(19) United States
(12) Patent Application Publication
(10) Pub. No.: US 2013/0229342 A1
(43) Pub. Date: Sep. 5, 2013

(54) INFORMATION PROVIDING SYSTEM, INFORMATION PROVIDING METHOD, INFORMATION PROCESSING APPARATUS, METHOD OF CONTROLLING THE SAME, AND CONTROL PROGRAM

(71) Applicants: Yuriko Hiyama, Tokyo (JP); Tomoyuki Oosaka, Tokyo (JP)

(72) Inventors: Yuriko Hiyama, Tokyo (JP); Tomoyuki Oosaka, Tokyo (JP)

(73) Assignee: NEC CORPORATION, Tokyo (JP)

(21) Appl. No.: 13/823,517

(22) PCT Filed: Sep. 26, 2011
(86) PCT No.: PCT/JP2011/071802

§ 371 Date: May 21, 2013

(30) Foreign Application Priority Data
Nov. 10, 2010 (JP) 2010-251678

(51) Int. Cl. G06F 3/01

(52) U.S. Cl. CPC G06F 3/017
USPC 345/156

(57) ABSTRACT

An apparatus of this invention is an information processing apparatus for providing information to general public. This information processing apparatus displays a screen including an inducement image to induce a hand motion. The hand motions of persons in the sensed public are recognized. According to the feature of this invention, out of the persons in the sensed public, a person whose recognized hand motion corresponds to the hand motion to be induced by the inducement image is identified. The identified person is set as the advertising target person, thereby producing an opportunity for persons to pay attention to advertising information.

### TECHNICAL FIELD

The present invention relates to a technique of providing advertising information to general public.

### BACKGROUND ART

As a display system for providing information to general public, a system using digital signage is known. For example, patent literature 1 discloses a technique of judging the attention level to a display screen based on the attention time and the distance from the screen obtained from an image sensed by a camera and providing information suitable for a person who is paying attention to the display screen.

### CITATION LIST

### Patent Literature

Patent literature 1: Japanese Patent Laid-Open No. 2009-176254

### SUMMARY OF INVENTION

### Technical Problem

However, the technique of the above-described patent literature further increases the attention level assuming that a person is already paying attention to advertising information, but cannot produce an opportunity for persons to pay attention to the advertising information.

It is an object of the present invention to provide a technique of solving the above-described problem.

### Solution to Problem

In order to achieve the above-described object, an apparatus according to the present invention is an information processing apparatus for providing information to general public. The information processing apparatus comprises:

a first display control unit that controls to display a screen including an inducement image to induce a hand motion;

a recognition unit that recognizes hand motions of persons in the sensed public; and

an identifying unit that identifies, out of the persons in the sensed public, a person whose hand motion recognized by the recognition unit corresponds to the hand motion to be induced by the inducement image.

In order to achieve the above-described object, a method according to the present invention is a method of controlling an information processing apparatus for providing information to general public. The method comprises:

a first display control step of controlling to display a screen including an inducement image to induce a hand motion;

a recognition step of recognizing hand motions of persons in the sensed public; and

an identifying step of identifying, out of the persons in the sensed public, a person whose hand motion recognized in the recognition step corresponds to the hand motion to be induced by the inducement image.

In order to achieve the above-described object, a storage medium according to the present invention is a storage medium storing a control program of an information processing apparatus for providing information to general public. The control program causes a computer to execute:

a first display control step of controlling to display a screen including an inducement image to induce a hand motion;

a recognition step of recognizing hand motions of persons in the sensed public; and

an identifying step of identifying, out of the persons in the sensed public, a person whose hand motion recognized in the recognition step corresponds to the hand motion to be induced by the inducement image.

In order to achieve the above-described object, a system according to the present invention is an information providing system for providing information to general public. The information providing system comprises:

a display unit that displays a screen including advertising information;

a first display control unit that causes the display unit to display a screen including an inducement image to induce a hand motion;

a recognition unit that recognizes hand motions of persons in the sensed public;

an identifying unit that identifies, out of the persons in the sensed public, a person whose hand motion recognized by the recognition unit corresponds to the hand motion to be induced by the inducement image; and

a second display control unit that causes the display unit to display a screen including advertising information directed to the person identified by the identifying unit.

In order to achieve the above-described object, a method according to the present invention is an information providing method of providing information to general public. The information providing method comprises:

a first display control step of causing a display unit for displaying a screen including advertising information to display a screen including an inducement image to induce a hand motion;

a recognition step of recognizing hand motions of persons in sensed public;

an identifying step of identifying, out of the persons in the sensed public, a person whose hand motion recognized in the recognition step corresponds to the hand motion to be induced by the inducement image; and

a second display control step of causing the display unit to display a screen including advertising information directed to the person identified in the identifying step.

### Advantageous Effects of Invention

According to the present invention, it is possible to produce an opportunity for persons to pay attention to advertising information.

### BRIEF DESCRIPTION OF DRAWINGS

FIG. 1 is a block diagram showing the arrangement of an information processing apparatus according to the first embodiment of the present invention;

FIG. 2 is a block diagram showing the arrangement of an information providing system including an information processing apparatus according to the second embodiment of the present invention;

FIG. 3 is a block diagram showing the hardware structure of the information processing apparatus according to the second embodiment of the present invention;

FIG. 4 is a view showing the structure of data of sensed hands according to the second embodiment of the present invention;

FIG. 5 is a view showing the structure of a hand gesture DB according to the second embodiment of the present invention;

FIG. 6 is a view showing the structure of a target person judgment table according to the second embodiment of the present invention;

FIG. 7 is a flowchart showing the processing sequence of the information processing apparatus according to the second embodiment of the present invention;

FIG. 8 is a flowchart showing the processing sequence of an informing program execution process according to the second embodiment of the present invention;

FIG. 9 is a view showing the structure of a person recognition DB according to the third embodiment of the present invention;

FIG. 10 is a block diagram showing the structure of an informing program DB according to the third embodiment of the present invention;

FIG. 11 is a view showing the structure of an informing program selection table according to the third embodiment of the present invention;

FIG. 12 is a flowchart showing the processing sequence of an information processing apparatus according to the third embodiment of the present invention; and

FIG. 13 is a block diagram showing the arrangement of an information providing system according to the fourth embodiment of the present invention.

### DESCRIPTION OF EMBODIMENTS

The embodiments of the present invention will now be described in detail with reference to the accompanying drawings. Note that the constituent elements described in the following embodiments are merely examples, and the technical scope of the present invention is not limited by them.

### First Embodiment

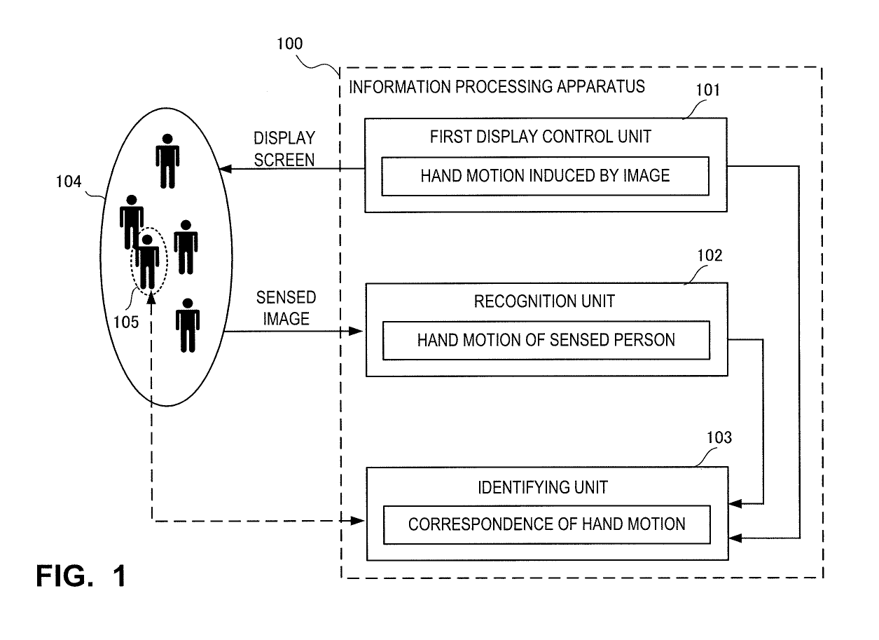

An information processing apparatus 100 according to the first embodiment of the present invention will be described with reference to FIG. 1. The information processing apparatus 100 is an apparatus for providing information to general public 104.

As shown in FIG. 1, the information processing apparatus 100 includes a first display control unit 101, a recognition unit 102, and an identifying unit 103. The first display control unit 101 controls to display a screen including an inducement image to induce hand motions. The recognition unit 102 recognizes hand motions of persons in the sensed public 104. If a hand motion recognized by the recognition unit 102 corresponds to the hand motion to be induced by the inducement image displayed by the first display control unit 101, the identifying unit 103 identifies a person 105 who has the hand motion, out of the persons in the sensed public.

According to this embodiment, it is possible to produce an opportunity for persons to pay attention to advertising information.

### Second Embodiment

In the second embodiment, an information processing apparatus will be explained, which enables to judge the depth using a stereo camera and easily detect a hand motion (to be referred to as a hand gesture hereinafter) more accurately. Additionally, an information processing apparatus will be explained, which enables to focus a camera or a video camera on a person (to be also referred to as a target person hereinafter) who has reacted to an inducement image to induce hand gestures and perform interaction with the target person using hand gestures.

### <Functional Arrangement of Information Providing System Including Information Processing Apparatus>

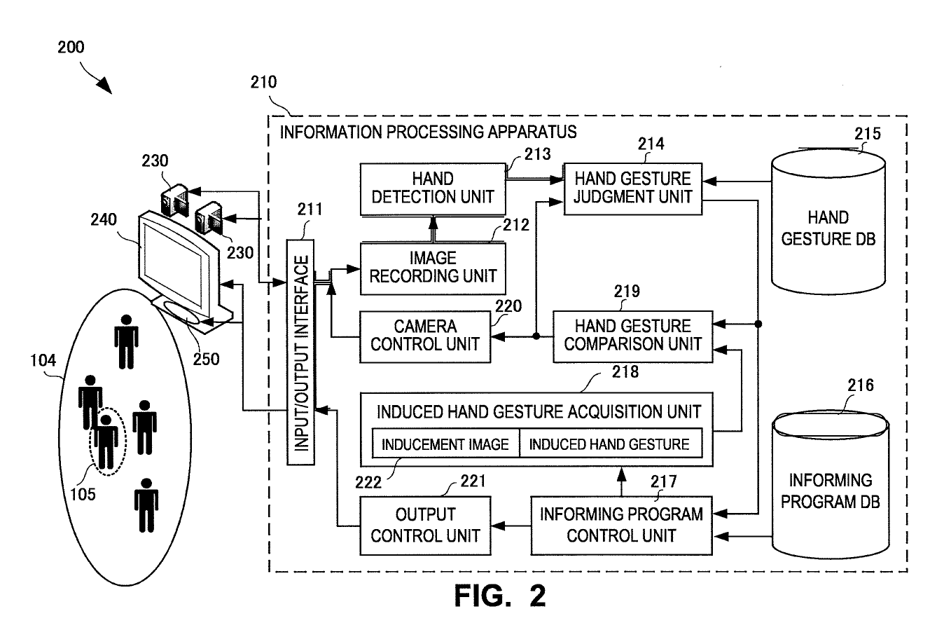

FIG. 2 is a block diagram showing the arrangement of an information providing system 200 including an information processing apparatus 210 according to the second embodiment. Note that although FIG. 2 illustrates the stand-alone information processing apparatus 210, the arrangement can also be extended to a system that connects plural information processing apparatuses 210 via a network. A database will be abbreviated as a DB hereinafter.

The information providing system 200 shown in FIG. 2 includes the information processing apparatus 210, a stereo camera 230, a display apparatus 240, and a speaker 250. The stereo camera 230 can sense persons in general public 104 and send the sensed image to the information processing apparatus 210, and also focus on a target person under the control of the information processing apparatus 210. The display apparatus 240 provides advertising information such as a publicity or advertising message in accordance with an informing program from the information processing apparatus 210. In this embodiment, a screen including an inducement image to induce a response using hand gestures by persons is displayed for the persons in the general public 104 in or prior to the publicity or advertising message. Upon confirming a person 105 who has responded in the image from the stereo camera 230, a screen interactive with the person 105 who has responded using hand gestures is output. The speaker 250 outputs auxiliary sound to assist inducement by the screen of the display apparatus 240 or to prompt interaction using hand gestures with the person 105 who has responded.

(Functional Arrangement of Information Processing Apparatus)

The information processing apparatus 210 includes the following constituent elements. Note that the information processing apparatus 210 need not always be a single apparatus, and it is necessary only that functions distributed to plural apparatuses can implement the function shown in FIG. 2 as a whole. Each functional component will be explained in accordance with a processing sequence according to this embodiment.

An input/output interface 211 implements the interface between the information processing apparatus 210 and the stereo camera 230, the display apparatus 240, and the speaker 250.

First, an informing program control unit 217 controls a predetermined informing program or an initial program. An output control unit 221, under control by the informing program or the initial program, transmits image data or sound data to the display apparatus 240 or the speaker 250 via the input/output interface 211. That is, the output control unit 221 functions as a display control unit that causes the display apparatus 240 to display an inducement image or advertising information to induce hand gestures of persons, and also functions as a sound output control unit that causes the speaker 250 to output sound corresponding to the inducement image or the advertising image.

The informing program includes contents (for example, inducement images representing a “hand waving” motion, a motion to call for participation in the game of rock, paper and scissors, a sign language, and the like) to induce hand gestures of the persons in the general public 104. When providing information by a predetermined informing program, the informing program control unit 217 selects the informing program from programs in an informing program DB 216. An induced hand gesture acquisition unit 218 that has obtained the contents of the initial program or informing program from the informing program control unit 217 acquires, from the obtained contents, an induced hand gesture that is required of the persons in the general public 104 by the program. The induced hand gesture acquisition unit 218 includes a table 222 that stores the correspondence between the inducement image included in the informing program and the hand gesture of persons to be induced by the inducement image.

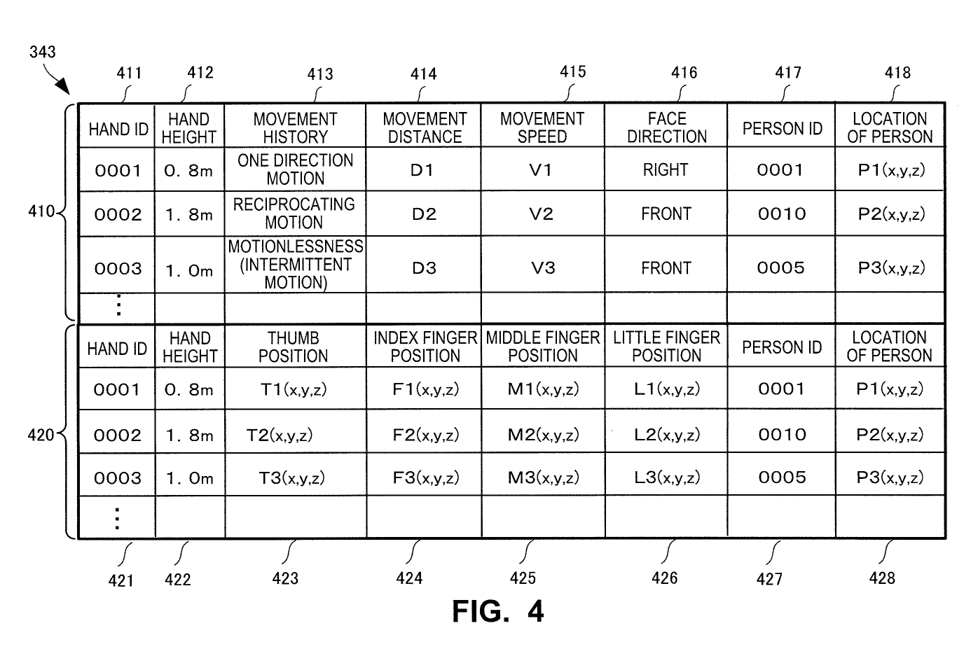

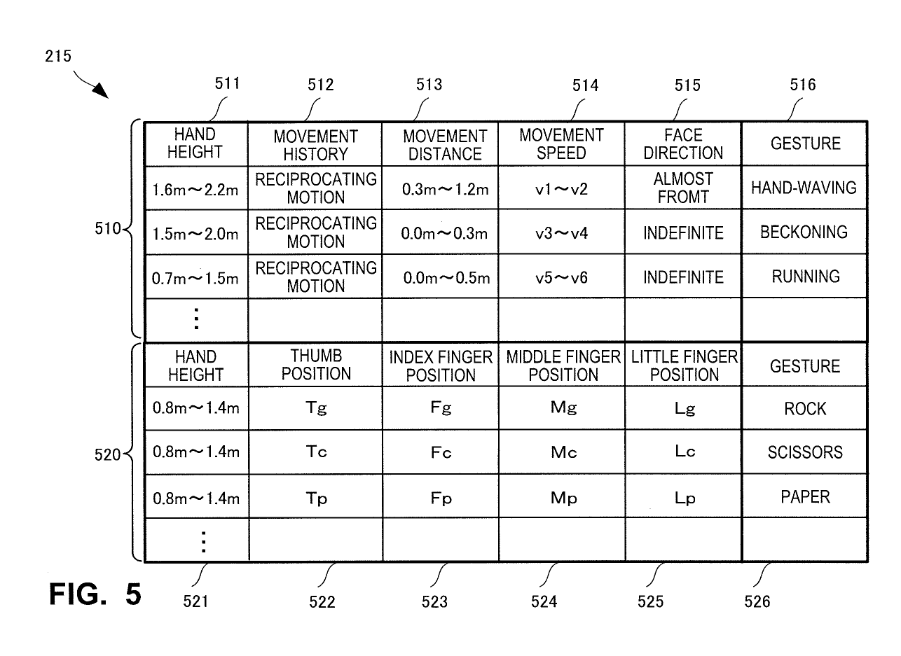

Next, the image of the general public 104 sensed by the stereo camera 230 is sent to an image recording unit 212 via the input/output interface 211, and an image history for a period in which hand gesture judgment is possible is recorded. A hand detection unit 213 detects a hand image from the image of the persons in the general public 104 sensed by the stereo camera 230. The hand image is detected based on, for example, the color, shape, and position. Note that if gloved hands are also included, a change can be made to prohibit selection by color in cooperation with judgment of a hand gesture judgment unit 214. The hand gesture judgment unit 214 refers to a hand gesture DB 215 and judges the hand gesture of each hand from the features (see FIG. 4) of the hand in the image of the persons in the general public 104 detected by the hand detection unit 213. The hand gesture DB 215 stores hand positions, finger positions, their time-series changes, or the like and the hand gestures with associated with each other (see FIG. 5).

A hand gesture comparison unit 219 compares the induced hand gesture obtained by the induced hand gesture acquisition unit 218 with the hand gesture of each hand judged by the hand gesture judgment unit 214. If the hand gestures match within a predetermined range as the result of comparison, the hand gesture comparison unit 219 outputs a signal representing matching of hand gestures. Note that the comparison by the hand gesture comparison unit 219 changes depending on the hand gesture. In, for example, hand waving, the finger positions and the like are not taken into consideration. In the game of rock, paper and scissors, if the hand gesture matches with any one of the rock, scissors, and paper, the judgment can be completed. In sign language, if the hand gesture falls into call/answer or the like within a predetermined range, it is judged to match.

The signal output from the hand gesture comparison unit 219 is input to the hand gesture judgment unit 214 and a camera control unit 220. Upon receiving the signal representing that the induced hand gesture corresponds to the hand gesture of the sensed hand, the hand gesture judgment unit 214 transmits information about the person (target person) who has the hand just judged to match, to the informing program control unit 217. The informing program control unit 217 displays, for the target person, a screen including notification information representing that his or her hand gesture is received. More specifically, the informing program control unit 217 responds to the target person by displaying a text or an image representing that his or her hand gesture is received from the target person or displaying the image of the target person on the screen. Although details will be described later in the third embodiment, it is possible to select an informing program or change the progress of the informing program in correspondence with the target person. On the other hand, the camera control unit 220 operates the stereo camera 230 to focus on the target person so as to specialize to the judgment of hand gestures of the target person and thereby implement smooth interaction with the target person in the informing program from then on.

Note that the processing and operation of the hand gesture comparison unit 219 and its connection to the other functional components in FIG. 2 are merely examples. Any arrangement other than that shown in FIG. 2 can be employed, if the arrangement can implement an operation of responding to person having the sensed hand when the induced hand gesture corresponds to the hand gesture of the sensed hand.

<Hardware Structure in Information Processing Apparatus>

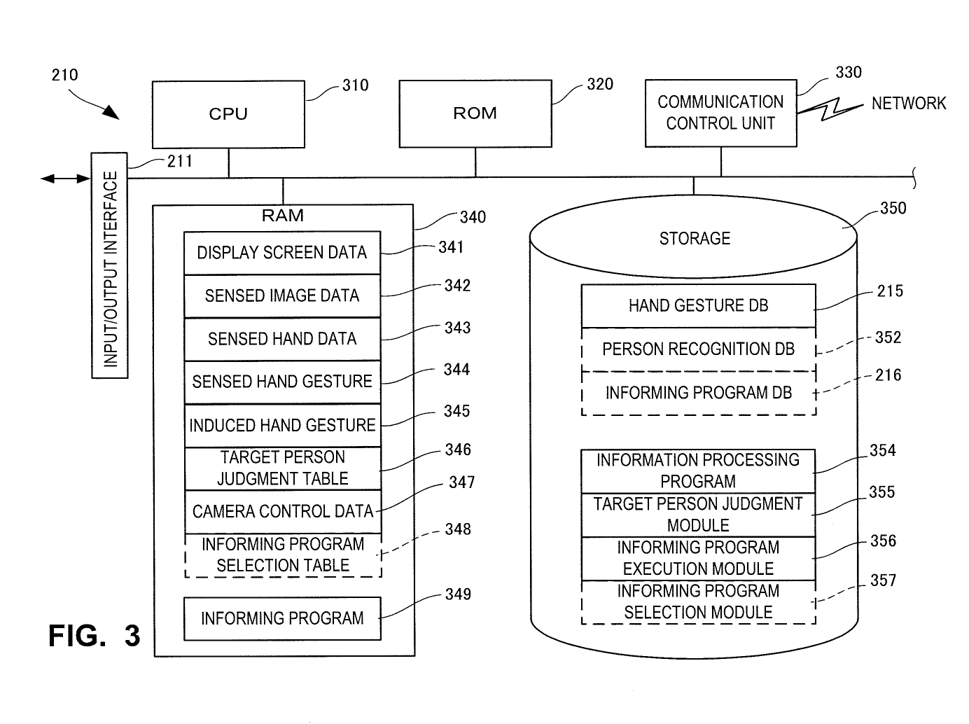

FIG. 3 is a block diagram showing the hardware structure of the information processing apparatus 210 according to the second embodiment. Note that data and programs used in the third embodiment are indicated by broken lines FIG. 3.

Referring to FIG. 3, a CPU 310 is a processor for arithmetic control and implements each functional component shown in FIG. 2 by executing a program. A ROM 320 stores initial data, permanent data of programs and the like, and the programs. A communication control unit 330 communicates with an external apparatus via a network. The communication control unit 330 may download informing programs from various kinds of servers and the like or transmit/receive signals to/from the stereo camera 230, the display apparatus 240, and the like via the network. Communication can be either wireless or wired. The input/output interface 211 interfaces to the stereo camera 230, the display apparatus 240, and the like, as in FIG. 2.

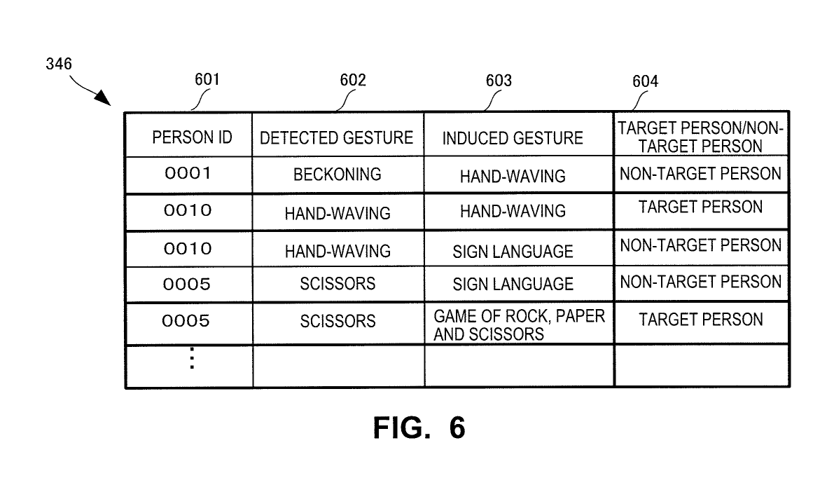

A RAM 340 is a random access memory used by the CPU 310 as a work area for temporary storage. An area to store data necessary for implementing the embodiment and an area to store an informing program are allocated in the RAM 340. Referring to FIG. 3, reference numeral 341 denotes display screen data displayed on the display apparatus 240; reference numeral 342 denotes image data sensed by the stereo camera 230; reference numeral 343 denotes data of a hand detected from the image data sensed by the stereo camera 230; reference numeral 344 denotes a hand gesture judged from the data of each sensed hand; and reference numeral 345 denotes an induced hand gesture induced by the inducement image included in the screen displayed on the display apparatus 240. A target person judgment table 346 is used to judge, when a sensed hand gesture corresponds to the induced hand gesture, the person who has the hand as the target person (see FIG. 6). Camera control data 347 is used for camera control to, for example, focus the stereo camera 230 on the judged target person. An informing program selection table 348 is used in the third embodiment to select an informing program based on the attribute of a target person judged from an image. Reference numeral 349 denotes an informing program currently executed by the information processing apparatus 210. Note that programs stored in another storage 350 are also loaded to the RAM 340 and executed by the CPU 310 to implement the functions of the respective functional components shown in FIG. 2.

The storage 350 shown in FIG. 3 is a mass storage device that nonvolatilely stores databases, various kinds of parameters, and programs to be executed by the CPU 310. The storage 350 stores the following data or programs necessary for implementing this embodiment.

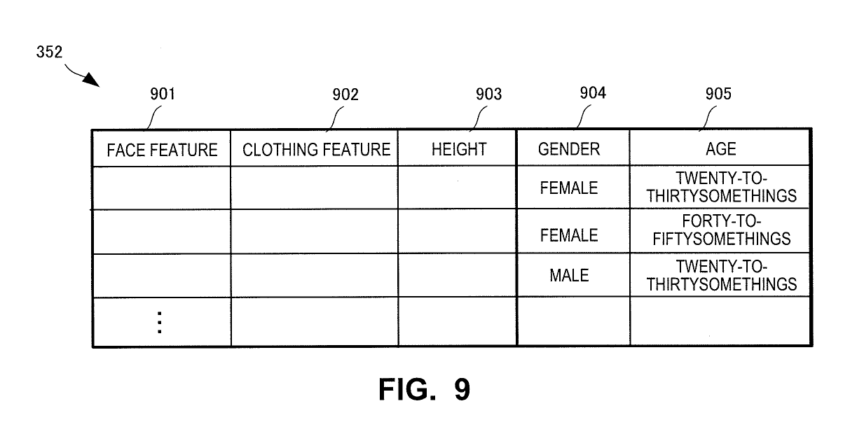

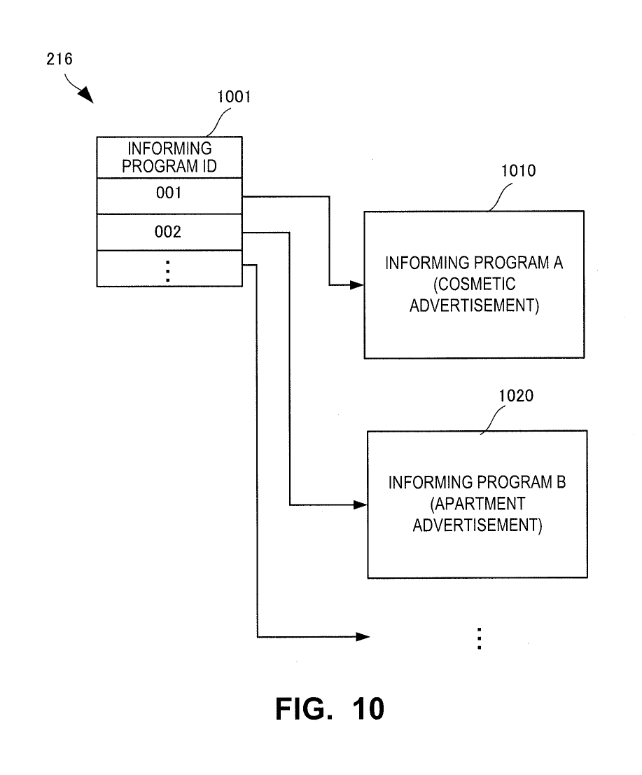

In this embodiment, the following databases are stored in addition to the hand gesture DB 215. A person recognition DB 352 is used in the third embodiment and stores the image features of the target person with associating attributes (for example, gender and age) with them to recognize, from the image, the attribute of the target person who has responded by a hand gesture (see FIG. 9). The informing program DB 216 is used particularly in the third embodiment and stores plural informing programs to be selected based on the attribute of the target person or an environment such as the day of week or time zone (see FIG. 10).

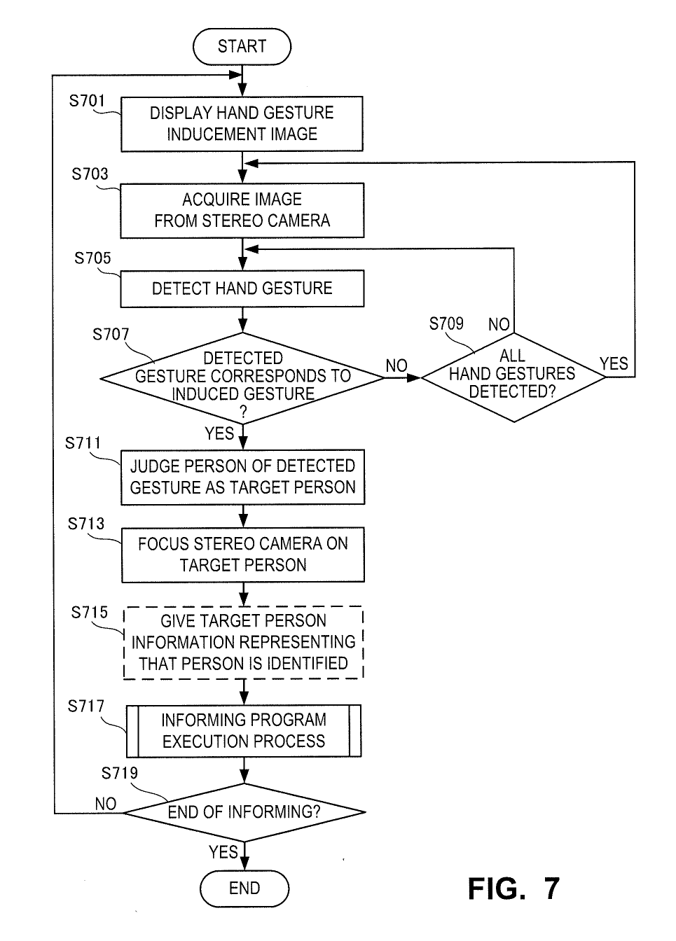

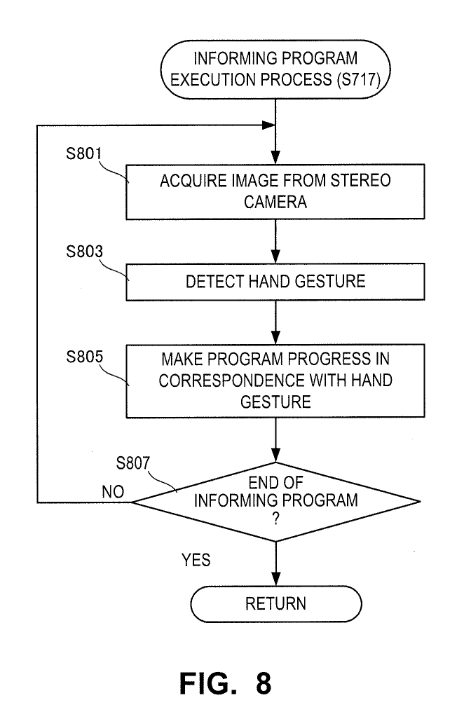

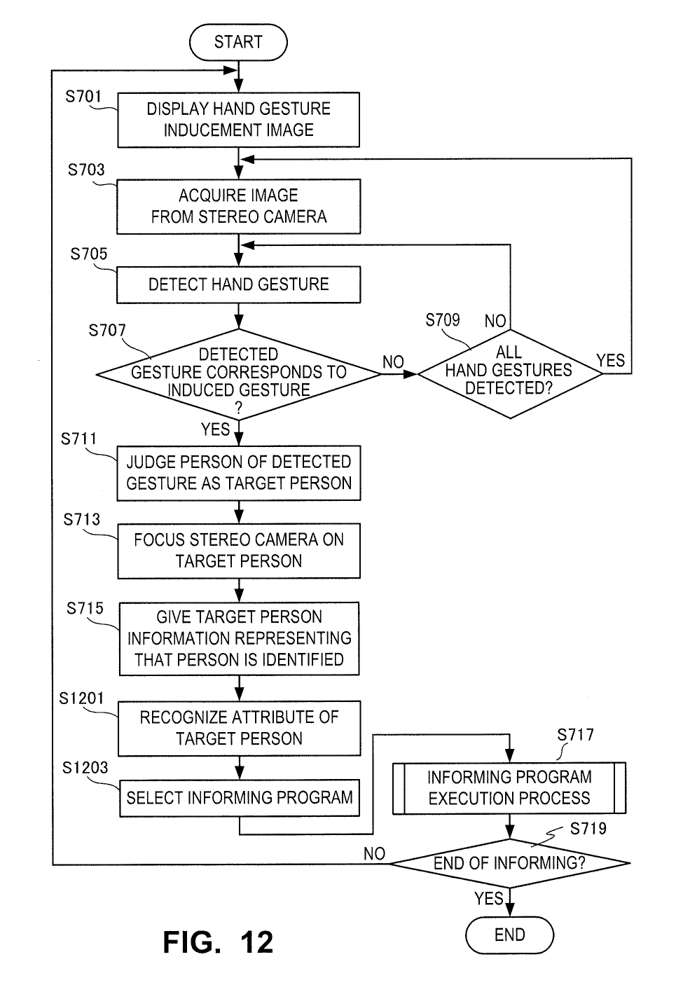

In this embodiment, the following programs are stored. An information processing program 354 is the main information processing program executed by the information processing apparatus 210 (see FIGS. 7 and 12). A target person judgment module 355 is included in the information processing program 354 and performs target person judgment. An informing program execution module 356 is included in the information processing program 354 and controls execution of an informing program (see FIG. 8). An informing program selection module 357 is included in the information processing program 354 and executed in the third embodiment to select an informing program in accordance with the attribute of the target person.

Note that FIG. 3 illustrates the data and programs indispensable in this embodiment but not general-purpose data and programs such as the OS.

<Structures of Data Used in Information Processing Apparatus>

The structures of characteristic data used in the information processing apparatus 210 according to the second embodiment will be described below.

<Structure of Data of Sensed Hands>

FIG. 4 is a view showing the structure of the data 343 of sensed hands according to the second embodiment.

FIG. 4 shows an example of the hand data 343 necessary for judging “hand-waving” or “game of rock, paper and scissors” as a hand gesture. Note that “sign language” and the like can also be judged by extracting hand data necessary for the judgment.

An upper stage 410 of FIG. 4 shows an example of data necessary for judging the “hand-waving” hand gesture. A hand ID 411 is added to each hand of persons in sensed general public to identify the hand. As a hand position 412, a height is extracted here. As a movement history 413, “one direction motion”, “reciprocating motion”, and “motionlessness (intermittent motion)” are extracted in FIG. 4. Reference numeral 414 denotes a movement distance; and reference numeral 415 denotes a movement speed. The movement distance and the movement speed are used to judge whether a gesture is, for example, a “hand-waving” gesture or a “beckoning” gesture. A face direction 416 is used to judge whether a person is paying attention. A person ID 417 is used to identify the person who has the hand. As a location 418 of person, the location where the person with the person ID exists is extracted. The focus position of the stereo camera 230 is determined by the location of person. In three-dimensional display, the direction of the display screen toward the location of person may be determined. The sound contents or directivity of the speaker 250 may be adjusted. Note that although the data used to judge the “hand-waving” hand gesture does not include finger position data and the like, the finger positions may be added.

A lower stage 420 of FIG. 4 shows an example of data necessary for judging the “game of rock, paper and scissors” hand gesture. A hand ID 421 is added to each hand of persons in sensed general public to identify the hand. As a hand position 422, a height is extracted here. Reference numeral 423 indicates a three-dimensional thumb position; reference numeral 424 indicates a three-dimensional index finger position; reference numeral 425 indicates a three-dimensional middle finger position; and reference numeral 426 indicates a three-dimensional little finger position. A person ID 427 is used to identify the person who has the hand. As a location 428 of person, the location where the person with the person ID exists is extracted. Note that a ring finger position is not included in the example shown in FIG. 4 but may be included. When not only the data of fingers but also the data of a palm or back and, more specifically, finger joint positions are used in the judgment, the judgment can be done more accurately.

Each data shown in FIG. 4 is matched with the contents of the hand gesture DB 215, thereby judging a hand gesture.

<Structure of Hand Gesture DB>

FIG. 5 is a view showing the structure of the hand gesture DB 215 according to the second embodiment. FIG. 5 shows DB contents used to judge “hand-waving” on an upper stage 510 and DB contents used to judge “game of rock, paper and scissors” on a lower stage 520 in correspondence with FIG. 4. Data for “sign language” are also separately provided.

The range of “hand height” used to judge each gesture is stored in 511 on the upper stage 510. A movement history is stored in a column 512. A movement distance range is stored in a column 513. A movement speed range is stored in a column 514. A face direction is stored in a column 515. A “hand gesture” for data (see FIG. 4) satisfying the conditions of the columns 511 to 515 is stored in a column 516. For example, a gesture satisfying the conditions of the first row is judged as a “hand-waving” gesture. A gesture satisfying the conditions of the second row is judged as a “beckoning” gesture. A gesture satisfying the conditions of the third row is judged as a “running” gesture. In this example, judging the “hand-waving” gesture suffices. FIG. 5 shows an example in which gestures that may be indistinguishable from the “hand-waving” gesture are judged. Conversely, to judge the “hand-waving” gesture as accurately as possible, both the type of hand data to be extracted and the structure of the hand gesture DB 215 are added or changed depending on what kind of data is effective.

The range of “hand height” used to judge each gesture is stored in a column 521 of the lower stage 520. Since the lower stage 520 stores data used to judge the “game of rock, paper and scissors” gesture, the “hand height” ranges are identical. A gesture outside the height range is not regarded as the “game of rock, paper and scissors”. A thumb position is stored in a column 522, an index finger position is stored in a column 523, a middle finger position is stored in a column 524, and a little finger position is stored in a column 525. A “hand gesture” for data (see FIG. 4) satisfying the conditions of the columns 521 to 525 is stored in a column 526. Note that the finger positions of the columns 522 to 525 are not the absolute positions of the fingers but the relative positions of the fingers. The finger position data shown in FIG. 4 are also used to judge the “game of rock, paper and scissors” gesture based on the relative position relationship by comparison. Although FIG. 5 shows no detailed numerical values, the finger position relationship of the first row is judged as “rock”. The finger position relationship of the second row is judged as “scissors”. The finger position relationship of the third row is judged as “paper”. As for the “sign language”, a time-series history is included, like the judgment of the “game of rock, paper and scissors”.

A hand having data that matches the data of the hand gesture DB 215 or falls within a predetermined range thereof is judged as the corresponding hand gesture. The hand gesture comparison unit 219 judges whether the “hand gesture” that is the result judged from the sensed hand corresponds to the “induced hand gesture” from the display screen of the display apparatus 240.

(Structure of Target Person Judgment Table)

FIG. 6 is a view showing the structure of the target person judgment table 346 according to the second embodiment.

FIG. 6 assumes that the gesture corresponding to the hand ID (0002)/person ID (0010) on the second row of the upper stage 410 shown in FIG. 4 is judged as the “hand-waving” gesture, and the gesture corresponding to the hand ID (0003)/person ID (0005) on the third row of the lower stage 420 shown in FIG. 4 is judged as the “scissors” gesture.

Reference numeral 601 shown in FIG. 6 denotes a person ID; reference numeral 602 denotes a gesture judged from a hand of a sensed image; reference numeral 603 denotes an “induced gesture” from the screen displayed on the display apparatus 240; and reference numeral 604 denotes a judged result representing that when the “induced gesture” corresponds to the “sensed gesture”, the person who has the hand is judged as the target person, and otherwise, the person is judged as a non-target person.

In the example shown in FIG. 6, when the “induced gesture” is “hand-waving”, the person with the person ID (0010) is judged as the “target person” who has responded to the screen because he or she is performing the “hand-waving” gesture. However, if the “induced gesture” is “sign language”, he or she is judged as the “non-target person”. When the “induced gesture” is “game of rock, paper and scissors”, the person with the person ID (0005) is judged as the “target person” who has responded to the screen because he or she is performing the “scissors” gesture. However, if the “induced gesture” is “sign language”, he or she is judged as the “non-target person”. Note that even when the “induced gesture” does not correspond to the “sensed gesture”, the person may preferentially be judged as the “target person” if the “hand-waving” gesture is performed toward the screen.

<Processing Sequence of Information Processing Apparatus>

FIG. 7 is a flowchart showing the processing sequence of the information processing apparatus according to the second embodiment. The CPU 310 shown in FIG. 3 executes this flowchart using the RAM 340, thereby implementing the functions of the respective functional components shown in FIG. 2.

In step S701, the display apparatus 240 displays an inducement image to induce hand gestures of persons in general public. In step S703, the stereo camera 230 performs sensing to acquire an image. In step S705, a hand is detected from the acquired image, and the “hand gesture” of the hand is detected. In step S707, it is judged whether the “detected gesture” corresponds to the “induced gesture”. If the “detected gesture” does not correspond to the “induced gesture”, the process advances to step S709 to judge whether the “hand gestures” of all hands in the acquired image are detected and judged. If the detection of the “hand gestures” of all hands has not ended, the process returns to step S705 to do judgment for the next hand. If the detection of the “hand gestures” of all hands has ended, the process returns to step S703 to acquire a new image from the stereo camera 230 and repetitively detect a “hand gesture”.

If the “detected gesture” corresponds to the “induced gesture”, the person who has the hand of the “detected gesture” is judged as the “target person” in step S711. That is, the person whose hand motion corresponding to the hand gesture to be induced by the inducement image is detected first is judged as the target person. In step S713, the stereo camera 230 is focused on the “target person” using the camera control unit 220. Step S715 is an optional process and is executed to provide the “target person” information representing that the apparatus has perceived the response of the “target person” to the inducement by the screen so as to establish closer contact with the “target person”. For example, the information may be provided by text display or sound. The information providing can also be performed by displaying the image of the “target person” sensed by the stereo camera 230 at part of the screen.

In step S717, execution of the informing program starts. FIG. 8 shows details of process of the information program. When execution of the informing program ends, it is judged in step S719 whether to end the information providing process. If the process is not to end, the process returns to step S701 to repeat the process.

(Processing Sequence of Informing Program Execution Process)

FIG. 8 is a flowchart showing the processing sequence of the informing program execution process S717. Note that the informing program requires the “target person” to change the display screen or select a choice on the display screen rather than inducing a hand gesture from the display screen.

Even during informing program execution, an image is acquired from the stereo camera 230 in step S801. In this case, since the camera focuses on the “target person” in step S713 of FIG. 7, an enlarged image of neighborhood including the “target person” is acquired. In step S803, the hand of the “target person” is extracted, and a “hand gesture” is detected. In step S805, the instruction of the “target person” by the detected “hand gesture” is judged, and the informing program is made to progress in correspondence with the instruction. The process returns to step S801 to repeat the process until the informing program is to end in step S807.

### Third Embodiment

In the third embodiment, the attribute (for example, gender or age) of a person judged to be a “target person” based on a hand gesture is judged based on an image from a stereo camera 230, and an informing program corresponding to the judged attribute is selected and executed, in addition to the second embodiment. Note that not only the attribute of the “target person” but also the clothing or behavior tendency, or whether he or she belongs to a group may be judged, and an informing program may be selected in accordance with the judged result. According to this embodiment, it is possible to cause the selected informing program to continuously attract the “target person”.

The arrangements of an information providing system and an information processing apparatus according to the third embodiment are similar to the second embodiment, and a description thereof will not be repeated. Added portions will be explained below.

<Structures of Data Used in Information Processing Apparatus>

In an information processing apparatus 210 according to the third embodiment, a person recognition DB 352, an informing program DB 216, and an informing program selection table 348 indicated by the broken lines in FIG. 3 are added as data. As a program, an informing program selection module 357 is added to part of an information processing program 354.

(Structure of Person Recognition DB)

FIG. 9 is a view showing the structure of the person recognition DB 352 according to the third embodiment.

Although FIG. 9 does not illustrate the contents in detail, a “gender” 904 and an “age” 905 are stored with associating a “face feature” 901, a “clothing feature” 902, a “height” 903, and the like obtained from a sensed image of a “target person” with them. This structure is merely an example, and the present invention is not limited to this.

(Structure of Informing Program DB)

FIG. 10 is a block diagram showing the structure of the informing program DB 216 according to the third embodiment.

In FIG. 10, an informing program ID 1001 used to identify an informing program and serving as a key of readout is stored. An informing program A 1010 and an informing program B 1020 can be read out by the informing program IDs “001” and “002” in FIG. 10, respectively. In the example shown in FIG. 10, the informing program A is assumed to be a “cosmetic advertisement” program, and the informing program B is assumed to be an “apartment advertisement” program. An informing program corresponding to the attribute of the “target person” recognized using the person recognition DB 352 is selected from the informing program DB 216 and executed.

(Structure of Informing Program Selection Table)

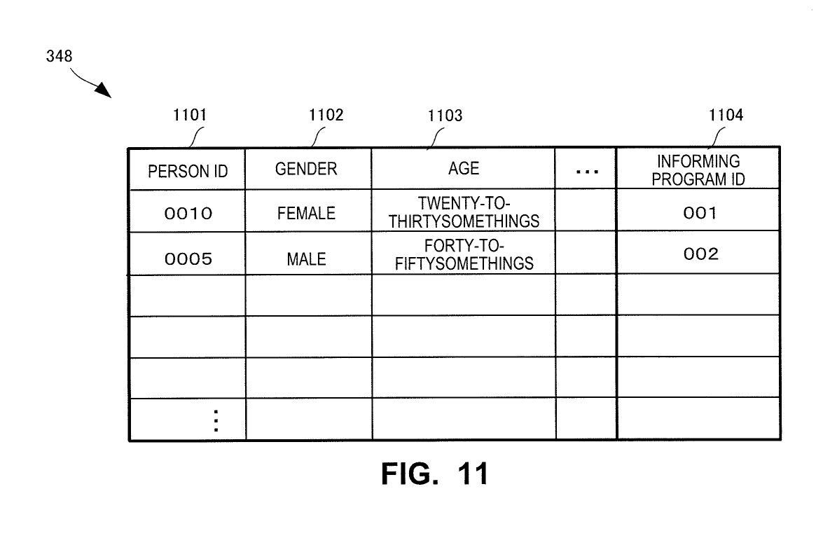

FIG. 11 is a view showing the structure of an informing program selection table 348 according to the third embodiment.

Referring to FIG. 11, reference numeral 1101 denotes a person ID of a “target person” judged by a hand gesture; reference numeral 1102 denotes a “gender” of the “target person” recognized by the person recognition DB 352; and reference numeral 1103 denotes an “age” of the “target person”. An informing program ID 1104 is determined in association with the attributes of the “target person” and the like. In the example shown in FIG. 11, the person with the person ID (0010) of the “target person” is recognized as a “female” in gender and twenty-to-thirtysomethings in “age”. For this reason, the informing program A of cosmetic advertisement shown in FIG. 10 is selected and executed. The person with the person ID (0005) of the “target person” is recognized as a “male” in gender and forty-to-fiftysomethings in “age”. For this reason, the informing program B of apartment advertisement shown in FIG. 10 is selected and executed. Note that the informing program selection is merely an example, and the However, the present invention is not limited to this.

<Processing Sequence of Information Processing Apparatus>

FIG. 12 is a flowchart showing the processing sequence of the information processing apparatus according to the third embodiment. The flowchart shown in FIG. 12 is obtained by adding steps S1201 and S1203 to the flowchart shown in FIG. 7. The remaining steps are the same as in FIG. 7, and the two steps will be explained here.

In step S1201, the attribute of the “target person” is recognized by referring to the person recognition DB 352 as shown in FIG. 9. In step S1203, an informing program is selected from the informing program DB 216 in accordance with the informing program selection table 348 shown in FIG. 11.

### Fourth Embodiment

In the second and third embodiments, processing by one information processing apparatus has been described. In the fourth embodiment, an arrangement will described in which plural information processing apparatuses are connected to an advertising information server via a network, and an informing program downloaded from the advertising information server is executed. According to this embodiment, the apparatuses can exchange information with each other. In addition, information can be concentrated to the advertising information server, and the advertisement/publicity can unitarily be managed. Note that the information processing apparatus of this embodiment can have the same functions as those of the information processing apparatus of the second or third embodiment, or some of the functions of the information processing apparatus may be transferred to the advertising information server. When not only the informing program but also the operation program of the information processing apparatus is downloaded from the advertising information server according to the circumstances, a control method based on hand gestures appropriate for the arrangement location is implemented.

Processing according to the fourth embodiment is basically the same as in the second and third embodiments regardless of the function distribution. Hence, the arrangement of the information providing system will be explained, and a detailed description of the functions will be omitted.

<Arrangement of Information Providing System>

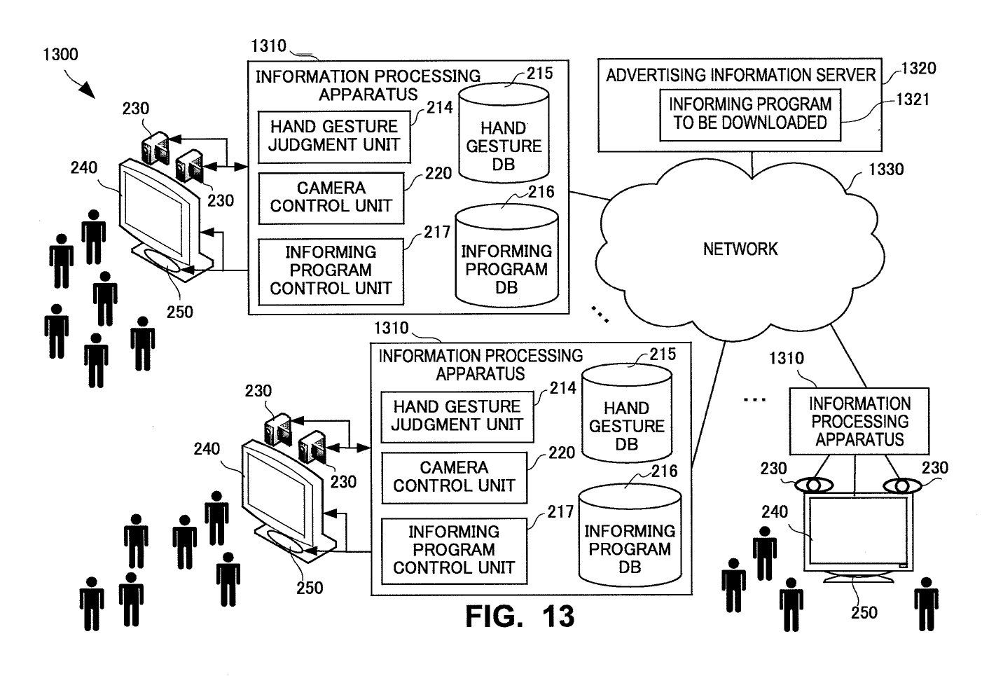

FIG. 13 is a block diagram showing the arrangement of an information providing system 1300 according to the fourth embodiment. The same reference numerals as in FIG. 2 denote constituent elements having the same functions in FIG. 13. Different points will be explained below.

FIG. 13 shows three information processing apparatuses 1310. The number of information processing apparatuses is not limited. The information processing apparatuses 1310 are connected to an advertising information server 1320 via a network 1330. The advertising information server 1320 stores an informing program 1321 to be downloaded. The advertising information server 1320 receives information of each site sensed by a stereo camera 230 and selects an informing program to be downloaded. This enables to perform integrated control to, for example, cause plural display apparatuses 240 to display inducement images of associated hand gestures.

Note that FIG. 13 illustrates the information processing apparatuses 1310 each including a hand gesture judgment unit 214, a hand gesture DB 215, an informing program DB 216, an informing program control unit 217, and a camera control unit 220 as characteristic constituent elements. However, the present invention is not limited to this. Some of the functions of the information processing apparatus 1310 may be distributed to the advertising information server 1320 or another apparatus.

### Other Embodiments

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims. The embodiments of the present invention have been described above in detail. A system or apparatus formed by combining separate features included in the respective embodiments in any form is also incorporated in the present invention.

The present invention can be applied to a system including plural devices or a single apparatus. The present invention can be applied to a case in which a control program for implementing the functions of the embodiments is supplied to the system or apparatus directly or from a remote site. Hence, the control program installed in a computer to implement the functions of the present invention by the computer, or a storage medium storing the control program or a WWW (World Wide Web) server to download the control program is also incorporated in the present invention.

This application claims the benefit of Japanese Patent Application No. 2010-251678, filed Nov. 10, 2010, which is hereby incorporated by reference herein in its entirety.

1. An information processing apparatus for providing information to general public, comprising:
a first display control unit that controls to display a screen including an inducement image to induce a hand motion;
a recognition unit that recognizes hand motions of persons in the sensed public; and
an identifying unit that identifies, out of persons in the sensed public, a person whose hand motion recognized by said recognition unit corresponds to the hand motion to be induced by the inducement image.

2. The information processing apparatus according to claim 1, wherein
said identifying unit has a storage unit that stores the inducement image and the hand motion to be induced by the inducement image with associated with each other, to judge a correspondence between the inducement image and the recognized hand motion by referring to said storage unit.

3. The information processing apparatus according to claim 1, further comprising a second display control unit that controls to display a screen including advertising information directed to the person identified by said identifying unit.

4. The information processing apparatus according to claim 3, wherein
said recognition unit recognizes a hand motion of the person as a target person, after said second display control unit has started displaying the screen including the advertising information directed to the person, and
said second display control unit control to display a screen including advertising information in response to the hand motion of the target person.

5. The information processing apparatus according to claim 3, wherein said second display control unit controls to notify the person that a hand motion corresponding to the hand motion induced by the image displayed by said first display control unit is returned, before displaying the screen including the advertising information directed to the person.

6. The information processing apparatus according to claim 3, wherein said second display control unit control to display the screen including at least one of an image obtained by sensing the person identified by said identifying unit and an image of a hand of the person.

7. The information processing apparatus according to claim 1, wherein the hand motion includes a finger motion.

8. The information processing apparatus according to claim 1, wherein said recognition unit recognizes the hand motion of the sensed person based on two images sensed by a stereo camera.

9. The information processing apparatus according to claim 1, wherein the inducement image includes an image representing one of a hand-waving motion and a sign language.

10. The information processing apparatus according to claim 1, wherein the inducement image includes an image representing a hand motion used in a game of rock, paper and scissors.

11. The information processing apparatus according to claim 1, wherein when said recognition unit has recognized hand motions of plural persons, said identifying unit identifies a person whose hand motion corresponding to the hand gesture to be induced by the inducement image is detected first by said recognition unit, out of the plural persons.

12. The information processing apparatus according to claim 1, further comprising a sound output control unit that control to output sound corresponding to the image displayed by said first display control unit.

13. A method of controlling an information processing apparatus for providing information to general public, comprising:
a first display control step of controlling to display a screen including an inducement image to induce a hand motion;
a recognition step of recognizing hand motions of persons in the sensed public; and
an identifying step of identifying, out of the persons in the sensed public, a person whose hand motion recognized in the recognition step corresponds to the hand motion to be induced by the inducement image.

14. A storage medium storing a control program of an information processing apparatus for providing information to general public, said control program causing a computer to execute:
a first display control step of controlling to display a screen including an inducement image to induce a hand motion;
a recognition step of recognizing hand motions of persons in the sensed public; and
an identifying step of identifying, out of the persons in the sensed public, a person whose hand motion recognized in the recognition step corresponds to the hand motion to be induced by the inducement image.

15. An information providing system for providing information to general public, comprising:
a display unit that displays a screen including advertising information;
a first display control unit that causes said display unit to display a screen including an inducement image to induce a hand motion;
a recognition unit that recognizes hand motions of persons in the sensed public;
an identifying unit that identifies, out of the persons in the sensed public, a person whose hand motion recognized by said recognition unit corresponds to the hand motion to be induced by the inducement image; and
a second display control unit that causes said display unit to display a screen including advertising information directed to the person identified by said identifying unit.

16. An information providing method of providing information to general public, comprising:
a first display control step of causing a display unit for displaying a screen including advertising information to display a screen including an inducement image to induce a hand motion;
a recognition step of recognizing hand motions of persons in sensed public;
an identifying step of identifying, out of the persons in the sensed public, a person whose hand motion recognized in the recognition step corresponds to the hand motion to be induced by the inducement image; and
a second display control step of causing the display unit to display a screen including advertising information directed to the person identified in the identifying step.
